(19) United States
(12) Patent Application Publication
(10) Pub. No.: US 2010/0167016 A1
(43) Pub. Date: Jul. 1, 2010

(54) POLYESTER FILM FOR MOLDED PART

(75) Inventors: Isao Manabe, Shiga (JP); Ryosuke Matsui, Kyoto (JP); Masahiro Kimura, Kyoto (JP)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Toray Industries, Inc., Chuo-ku, Tokyo (JP)

(21) Appl. No.: 12/278,815

(22) PCT Filed: Feb. 15, 2007
(86) PCT No.: PCT/JP2007/052666

§ 371 Date: Sep. 3, 2008

(30) Foreign Application Priority Data
Feb. 15, 2006 (JP) 2006-037527

(51) Int. Cl. B29C 45/14; B32B 15/09; B29C 55/12; B29D 7/01; C08L 35/02

(52) U.S. Cl. 428/161; 428/458; 264/212; 428/156; 525/225

(57) ABSTRACT

A polyester film for molded part having low strain stress in processing, thermoforming in a target shape is easy and appearance is excellent even when a metallic thin membrane is provided. A polyester film for molded part includes a film having a polyester resin composition mixed with a resin (A) of polyethylene terephthalate and a resin (B) of polyester selected from the group consisting of a polybutylene terephthalate resin and a polytrimethylene terephthalate resin where a resin (A) is 10 to 90% by mass and a resin (B) is 90 to 10% by mass based on the total of resin (A) and resin (B), wherein the resin (B) of polyester comprises a resin (B1) of polybutylene terephthalate and a resin (B2) of polytrimethylene terephthalate being mixed such that a resin (B1) is 10 to 90% by mass and a resin (B2) is 90 to 10% by mass based on the total of resin (B1) and resin (B2), and a ratio (D/H) of a half bandwidth D (° C.) of a recrystallization peak in falling temperature by differential scanning calorimeter (DSC) to the peak height H (mW) is 3 to 150° C./mW.

### RELATED APPLICATIONS

This is a §371 of International Application No. PCT/JP2007/052666, with an international filing date of Feb. 15, 2007 (WO 2007/094382, published Aug. 23, 2007), which is based on Japanese Patent Application No. 2006-037527, filed Feb. 15, 2006.

### TECHNICAL FIELD

This disclosure relates to polyester films, particularly, a polyester film for molded part, which can be suitably used as a metallic molded part processed after metal deposition is conducted on a film surface, as a surface protection film in molding a formable decorative sheet, and the like.

### BACKGROUND

In recent years, for building materials, automobile parts, cellular phones, electric products, and the like, parts having a metallic appearance by injection molding of resin and plating thereof, and highly decorative parts by coating have been largely used. However, as increasing concerns about environmental problems, influences on environments by plating liquids in a chemical bath upon plating resins, solvents discharged in a painting process and carbon dioxide have been viewed with suspicion. In particular, it is necessary to work on prevention of leakage of plating liquids, further there has been a movement to regulate the plating liquid itself.

In such situations, as a metallic molded part replacing plating, a laminate that metal deposition is conducted on a polyester film to laminate other material has been proposed (for example, see Japanese Unexamined Patent Publication No. 2000-43212). Further, a laminated film having brightness in the same constitution has been disclosed (for example, see Japanese Unexamined Patent Publication Nos. 2004-174881 and 2004-175064). However, since ordinary, biaxially stretched polyester films in these proposals have been used, it is not possible to produce a molded part with a complicated shape as being plated on injection molded articles.

Further, several proposals have been made for polyester films capable of being used as a metallic molding film. First, a polyester film consisting of polyethylene terephthalate as a main constituent and containing other compositions has been disclosed (for example, see Japanese Unexamined Patent Publication No. 2000-94575). However, formability of the film by this proposal is far from required characteristics. Next, a polyester film with a specific melting temperature and tensile elongation at break, being excellent in formability, has also been proposed (for example, see Japanese Unexamined Patent Publication No. 2001-72841). However, regarding the film by this proposal, it is difficult to conduct thermoforming precisely because strain stress is too high in processing. Further, a film that polyethylene terephthalate and polybutylene terephthalate are mixed by 1:1 to provide formability has been proposed (for example, see Japanese Unexamined Patent Publication No. 2002-321277). However, it is difficult to obtain an excellent metallic film by this film. Further, there has been proposed a formable polyester film that a specific half bandwidth of recrystallization peak is realized, and crystallizability is controlled by mixing a plurality of polyester resins (for example, see Japanese Unexamined Patent Publications Nos. 2003-268131 and 2005-75904). However, there has been a problem that crystallizability is high and strain stress is too high in processing because the half bandwidth of recrystallization peak is too narrow.

Further, movements that a decorative sheet is used in molded articles as an alternative of painting are active. There have been used methods that vacuum forming, vacuum pressure, forming, plug assist forming and the like are conducted using a decorative sheet. However, in this case, in severe molding processes such as heating, pushing a mold up and vacuuming, there are problems that surface is scarred and surface gloss is lowered. Hence, a proposal that a masking film capable of thermoforming is laminated has been made (for example, see Tokuhyo Application No. 2001-514984 (Japanese translation of PCT publication)).

However, in this proposal, the masking film is an unoriented urethane film to be case directly on a decorative sheet, rigidity of the film is too low to satisfy peel property after molding and the surface condition of decorative sheet after molding.

Further, as a metallic decorative sheet with formability, to prevent scar in molding, a formable laminate that a mask layer is laminated has been proposed (for example, see U.S. Pat. No. 6,565,955). As the mask layer, a film with high elongation made of polyester, nylon, polyurethane or the like has been proposed. However, since stress in molding is not sufficiently low in this proposal, in molding a formable laminate, molding following is not sufficient, and peel property after molding is bad, thus, there has been a problem that fragments of protection film are remained on the surface of a metallic decorative sheet with formability.

It could therefore be helpful to provide a polyester film for molded part where strain stress is low in processing, thermoforming in a target shape is easy, and appearance is excellent even when disposing a metal thin membrane, further, provide a polyester film for molded part suitable for a surface protection film of a decorative sheet.

### SUMMARY

We thus provide:
(1) A polyester film for molded part, being a film comprising a polyester resin composition mixed with a resin (A) of polyethylene terephthalate and a resin (B) of polyester selected from the group consisting of a polybutylene terephthalate resin and a polytrimethylene terephthalate resin where a resin (A) is 10 to 90% by mass and a resin (B) is 90 to 10% by mass based on the total of resin (A) and resin (B), wherein the resin (B) of polyester comprises a resin (B1) of polybutylene terephthalate and a resin (B2) of polytrimethylene terephthalate being mixed such that a resin (B1) is 10 to 90% by mass and a resin (B2) is 90 to 10% by mass based on the total of resin (B1) and resin (B2), and
   a ratio (D/H) of a half bandwidth D (° C.) of a recrystallization peak in falling temperature by differential scanning calorimeter (DSC) to the peak height H (mW) to 150° C./mW.
(2) The polyester film for molded part described in (1), wherein a recrystallization peak temperature (Tmc) in falling temperature by differential scanning calorimeter (DSC) is 140 to 205° C.
(3) The polyester film for molded part described in (1) or (2), being a biaxially oriented film.
(4) The polyester film for molded part described in any one of (1) to (3), wherein the polyester resin composition is mixed in such that the resin (A) is 60 to 90% by mass and the resin (B) is 40 to 10% by mass based on the total of resin (A) and resin (B).
(5) The polyester film for molded part described in any one of (1) to (4), wherein a melting peak in raising temperature by differential scanning calorimeter (DSC) is a single peak.
(6) A film for metallic molded part, wherein a metal compound is deposited on at least one side of the biaxially oriented polyester film for molded part described in any one of (1) to (5).
(7) The biaxially oriented polyester film for molded part described in any one of (1) to (6), being used by being laminated on the surface of a formable decorative sheet,
(8) A formable laminate, wherein the biaxially oriented polyester film for molded part described in any one of (1) to (7) is laminated on the surface of a formable decorative sheet.
(9) A forming method of a formable decorative sheet, comprising performing the formable laminate described in (8), conducting trimming, injecting a resin, and then peeling the biaxially oriented polyester film for molded part described in any one of (1) to (7).
(10) A molded part obtained by peeling the biaxially oriented polyester film for molded part described in any one of (1) to (7) after molding the formable laminate described in (8), wherein an absolute value of difference in glass between the part and the formable decorative sheet before molding is less than 10.

The polyester film for molded part can be suitably used as metallic molded parts in that it is easy to process by thermoforming and a thin membrane composed of metal compounds is formed on a film surface. Further, since strain stress is low in processing, in particular, when it is used as a surface protection film in molding a formable decorative sheet, it is possible to keep the appearance of molded part excellent after molding. The polyester filth for molded part is preferably used as a surface protection film of a formable decorative sheet. A molded part produced by using the polyester film for molded part was few in scar of surface and less in lowering of gloss as well as excellent in surface nature.

### BRIEF DESCRIPTION OF THE DRAWINGS

FIG. 1 is a DSC curve as an example of measurement of exoergic peak of recrystallization in falling temperature by differential scanning calorimeter (DSC).

### DESCRIPTION OF NUMBER AND SYMBOL

L: Base line on the basis of plane part on a DSC curve of high temperature side of exoergic peak
P: Exoergic peak top
H: Peak height
D: Half bandwidth of exoergic peak at height H/2
Tmc: Recrystallization peak temperature at temperature of exoergic peak top

### DETAILED DESCRIPTION

For the polyester film, it is necessary from the viewpoint of formability required for molded parts to comprise a resin (A) of polyethylene terephthalate and a resin (B) of polyester selected from a polybutylene terephthalate resin and a polytrimethylene terephthalate resin.

The resin (A) of polyethylene terephthalate is a resin comprising 100 mol % of polyethylene terephthalate as a constituent, or polyethylene terephthalate copolymerized with less than 20 mol % of a copolymerizable component (however, except for diethylene glycol being by-product as a copolymerizable component). Examples of copolymerizable components for polyethylene terephthalate include aliphatic dihydroxy compounds such as 1,2-propanediol, 1,3-propanediol, 1,3-butanediol, 1,4-butanediol, 1,5-pentanediol, 1,6-hexanediol and neopentyl glycol; polyoxyalkylene glycols such as polyethylene glycol, polypropylene glycol and polytetramethylene glycol; alicyclic dihydroxy compounds such as 1,4-cyclohexane dimethanol; and aromatic dihydroxy compounds such as bisphenol A and bisphenol S. Further, examples of preferable dicarboxylic acid components include aromatic dicarboxylic acids such as 2,6-naphthalene dicarboxylic acid, isophthalic acid, diphenyldicarboxylic acid, diphenylsulfone dicarboxylic acid, diphenoxyethane dicarboxylic acid, 5-sodiumsulfone dicarboxylic acid and phthalic acid; aliphatic dicarboxylic acids such as oxalic acid, succinic acid, adipic acid, sebacic acid, dimer acid, maleic acid and fumaric acid; alicyclic dicarboxylic acid such as 1,4-cyclohexane dicarboxylic acid; and oxycarboxylic acids such as paraoxybenzoic acid. Further, examples of dicarboxylate derivatives can include esters of the dicarboxylic acid compounds, for example, dimethyl terephthalate, diethyl terephthalate, 2-hydroxyethylmethyl terephthalate, dimethyl 2,6-naphthalene dicarboxylate, dimethyl isophthalate, dimethyl adipate, diethyl maleate and dimethyl dimer acid.

Further, a polybutylene terephthalate resin and a polytrimethylene terephthalate resin constituting a resin (B) of polyester are a resin comprising 100 mol % of polybutylene terephthalate as a constituent and a resin comprising 100 mol % of polytrimethylene terephthalate as a constituent, or a resin comprising, as a constituent, polybutylene terephthalate, and polyester in which polytrimethylene terephthalate are copolymerized with less than 20 mol % of a copolymerizable component. Examples of copolymerizable components for a resin (B) of polyester include aliphatic dihydroxy compounds such as ethylene glycol, 1,2-propanediol, butanediol, 1,5-pentanediol, 1,6-hexanediol and neopentyl glycol; polyoxyalkylene glycols such as polyethylene glycol, polypropylene glycol and polytetramethylene glycol; alicyclic dihydroxy compounds such as 1,4-cyclohexane dimethanol; and aromatic dihydroxy compounds such as bisphenol A and bisphenol S. Further, examples of preferable dicarboxylic acid components include aromatic dicarboxylic acids such as 2,6-naphthalene dicarboxylic acid, isophthalic acid, diphenyldicarboxylic acid, diphenylsulfone dicarboxylic acid, diphenoxyethane dicarboxylic acid, 5-sodiumsulfone dicarboxylic acid and phthalic acid; aliphatic dicarboxylic acids such as oxalic acid, succinic acid, adipic acid, sebacic acid, dimer acid, maleic acid and fumaric acid alicyclic dicarboxylic acids such as 1,4-cyclohexane dicarboxylic acid; and oxycarboxylic acids such as paraoxybenzoic acid. Further, examples of dicarboxylate derivatives can include esters of the dicarboxylic acid compounds, for example, dimethyl terephthalate, diethyl terephthalate, 2-hydroxyethylmethyl terephthalate, dimethyl 2,6-naphthalene dicarboxylate, dimethyl isophthalate, dimethyl adipate, diethyl maleate and dimethyl dimer acid.

For the polyester film, it is necessary from the viewpoint of formability to be a film comprising a polyester resin composition mixed with a resin (A) of polyethylene terephthalate and a resin (B) of polyester selected from a polybutylene terephthalate resin and a polytrimethylene terephthalate resin where a resin (A) is 10 to 90% by mass and a resin (B) is 90 to 10% by mass based on the total of resin (A) and resin (B). When the resin (A) exceeds 90% by mass, formability improvement effect exhibited by mixing with the resin (B) is not observed, reversely when the resin (B) exceeds 90% by mass, crystallization speed of resin becomes too fast, a film-forming property, particularly stretching property deteriorates, and whitening due to crystallization becomes noticeable. As the mixing ratio of resin (A) and resin (B), it is preferable from the points of film-forming stability, heat resistance and formability that the resin (A) be 40 to 90% by mass and the resin (B) be 60 to 10% by mass based on the total of resin (A) and resin (B), and it is particularly preferable that the resin (A) be 60 to 90% by mass and the resin (B) be 40 to 10% by mass.

Moreover, it is necessary for controlling D/H in a range of 3 to 150° C./mW and exhibiting an excellent formability that resin (B) comprise a resin (B1) of polybutylene terephthalate and a resin (32) of polytrimethylene terephthalate being mixed in a ratio that a resin (B1) is 10 to 90% by mass and a resin (B2) is 90 to 10% by mass based on the total of resin (B1) and resin (B2). It is more preferable to be mixed in such that the resin (B1) be 30 to 70% by mass and the resin (B2) be 70 to 30% by mass, and it is particularly preferable to be mixed such that the resin (B1) be 40 to 60% by mass and the resin (B2) be 60 to 40% by mass. By setting the mixing ratio of resin (B1) and resin (B2) in a more preferable range, when making film is conducted by a stretching process in a transverse-direction after stretching in a machine-direction by successive biaxial stretching, since progress of crystallization is suppressed upon stretching in a machine-direction, stretching in a transverse-direction hardly becomes necking stretch. Therefore, the balance of orientation in the machine-direction and transverse-direction becomes good, which is very preferable because formability of the whole film is improved. When an absolute value of difference in F100 values of machine-direction and transverse-direction is less than 3 MPa, it is very good for the balance and preferable in the point of formability.

Further, by setting the mixing ratio of resin (B1) and resin (B2) in the preferable range, mobility of an amorphous part becomes high, and formability is improved. The mobility of an amorphous part can be estimated by density. The value of density differs depending on resins used in resin (A), resin (B), and their mixing ratio, the lower the value of density is, the fewer the crystal structure is, so it can be determined that the structure of the amorphous part is random and mobility is high. Density herein is a value that a sample cut to a square (3 mm×3 mm) is immersed overnight in a density gradient tube (aqueous NaBr solution, 25° C.) for evaluation. A preferable density range of the polyester film for molded part is 1.35 to 1.378 (g/cm³). When less than 1.35 (g/cm³), crystallizability may be markedly lowered, which is not preferable because of influence on heat resistance. Reversely when more than 1.378 (g/cm³), crystallizability becomes high and formability may become poor. To hold a suitable crystallizability and enhance the mobility of an amorphous part, the density is preferably from 1.354 to 1.376 (g/cm³), and most preferably from 1.358 to 1.374 (g/cm³).

Further, to set a density in a preferable range, it is effective that a mixing ratio of resin (B1) and resin (B2) is set in the range, and a film is formed by preferable film-forming conditions described below.

For the polyester film, it is necessary from the viewpoint of exhibiting an excellent formability that a ratio (D/H) of a half bandwidth D (° C.) of a recrystallization peak in falling temperature by differential scanning calorimeter (DSC) to the peak height H (mW) be 3 to 150° C./mW. When D/H is less than 3° C./mW, formability is inferior because crystallization speed is too high. On the other hand, when D/H is more than 150° C./mW, heat resistance is inferior because crystallizability is markedly low, further, when a thin membrane composed of a metal compound is formed on a film surface for a metallic film, and a deposition method is adopted, surface nature may markedly deteriorate due to heat upon deposition. From the viewpoints of formability and heat resistance, D/H is more preferably 5 to 120° C./mW, and particularly preferably 10 to 100° C./mW.

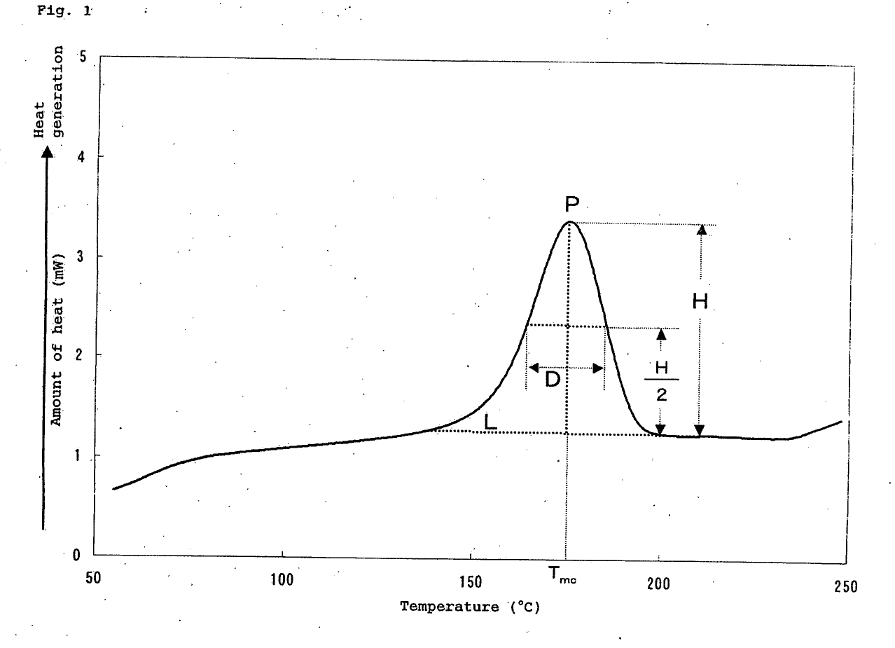

FIG. 1 shows a DSC curve as an example of measurement of an exoergic peak of recrystallization in falling temperature by differential scanning calorimeter (DSC). In this FIGURE, a base line L is drawn on a basis of a plane part on a DSC curve at a higher side than an exoergic peak, a height parallel to a vertical axis from the base line L to a top P of the exoergic peak is defined as a peak height H. Here, a spread of the exoergic peak by a line parallel to the base line L at H/2, height in half of height H, is calculated as a half bandwidth D of a recrystallization peak, form which D/H is obtained.

As a method to set a ratio (D/H) of a half bandwidth D (° C.) of a recrystallization peak in falling temperature by differential scanning calorimeter (DSC) to the peak height H (mW) to be 3 to 150° C./mW, it is preferable that resin (A) and resin (B) be subjected to a fine dispersion in an amorphous region by the order of nanometer. A specific method is not particularly limited, but the dispersion can be controlled by controlling the kind of extruder, shape of screw, extrusion temperature, residence time of resin in an extruder and the like. Example thereof include a method comprising, as a preliminary step of melt extrusion with an ordinary single screw extruder, compounding resin (A) and resin (B) by a twin screw extruder in a given mixing, ratio, and using it as a raw material of film; and a method of using an extruder of tandem method combined with a twin screw extruder and a single screw extruder. Above all, using a high-kneading segment for a screw of a twin screw extruder is preferable from the viewpoint of obtaining a uniform resin-mixed composition. Further, it is preferable that cylinder temperature of an extruder in melt extrusion and temperatures of polymer tube including a T-die and filter be set to 270 to 295° C., and a resin is extruded from a T-die through an average residence time of 10 to 60 min at a resin temperature of 265 to 290° C. When extrusion temperature is less than 265° C., there is a case that melt viscosity is high, a shear exothermic heat is generated, a polyester resin itself is then decomposed, and molecular weight is lowered, so that a formed film may be brittle. Further, when extrusion temperature is more than 290° C., there is a case that a film may become brittle due to thermal decomposition. An average residence time herein is a time until a polyester resin charged in an extruder is discharged from a T-die, and it can be suitably adjusted by a screw rotation speed of an extruder and a rotation speed of a gear pump. Further, as a resin (B) to be used, choosing one with low molecular weight is preferable because molecular mobility is high and fine dispersion in an amorphous region of resin (A) tends to occur on the order of nanometer order. Preferable molecular weights of resin (B1) and resin (B2) are 14000 to 25000, further preferably 15000 to 22000, and most preferably 16000 to 20000. Using both resin (B1) and resin (B2) in this molecular weight range is preferable because fine dispersion in an amorphous region improves formability.

As the polyester film, it is preferable that a recrystallization peak temperature (Tmc) in falling temperature by differential scanning calorimeter (DSC) is 140 to 205° C. Here, it is shown that the higher the Tmc, the faster the crystallization speed is, when Tmc is more than 205° C., there is a case that formability as a film for molded part is inferior because of high crystallizability of film. On the other hand, when Tmc is less than 140° C., there is a case that heat resistance is inferior because of markedly low crystallizability. Further, in a case where a thin membrane composed of metal compounds is formed on a film surface, when a deposition method is adopted, surface nature markedly deteriorates due to heat upon deposition, and a pinhole may occur in film. From the viewpoint of exhibiting an excellent characteristic as a film for molded part, Tmc is more preferably 0.145 to 190° C., and particularly preferably 150 to 180° C. Herein, FIG. 1 is an example of measurement of a recrystallization exoergic peak in falling temperature by differential scanning calorimeter (DSC). Tmc shows a temperature at an exoergic peak top P in a DSC curve.

As a method for setting a recrystallization peak temperature (Tmc) in falling temperature by differential scanning calorimeter (DSC) to be 140 to 205° C., it is a preferable method that resin (A) and resin (B) are mixed as uniformly as possible to melt extrude. For example, there are a method that as a preliminary step of melt extrusion by an ordinary single screw extruder, resin (A) and resin (B) are compounded by a twin screw extruder to be a given mixing ratio, which is used a raw material of a film; and a method of using an extruder of tandem method combined with a twin screw extruder and a single screw extruder. Above all, using a high-kneading segment for a twin screw extruder is preferable form the viewpoint of obtaining a uniform resin-mixed composition. Further, from the viewpoint of suppressing an ester exchange reaction, in a twin screw extruder, it is preferable that without vacuuming from a vent hole, melt extrusion be conducted after drying resin (A) and resin (B) in advance. This is because an ester exchange reaction may proceed explosively when resin (A) and resin (B) are kneaded under vacuum, so that the components of resin (A) and resin (B) may be into copolymerized randomly co-polymerized copolyester composition, and heat resistance and the like may be markedly inferior.

In the polyester film, it is preferable that a melting peak in raising temperature by differential scanning calorimeter (DSC) is a single peak. The fact that two or more melting peaks are observed is that polyester resins are not uniformly mixed, indicating that resin (A) and resin (B) form respective crystals, and resulting in appearing nonuniformity in film characteristic. Particularly in the case of thermoforming, there is a case that when a crystal with a low melting point is deformed while melting, a crystal with a high melting point remains as crystal, causing lacking in uniform formability and breakage in forming. Herein, a single peak denotes a state that only one clear extreme value is present in an endothermic direction on a DSC chart. Since a fine endotherm peak being less than 2 J/g derived from thermal history has an unclear extreme value, it is not considered as a melting peak. When only one extreme value is present in an endothermic direction on the chart, it is considered that resin (A) and resin (B) are compatible with each other. Hence, this is preferable because exhibition of formability by improvement of molecular mobility is admitted.

Since the polyester film for molded part has heat resistance and surface characteristic as well as excellent formability, it is preferably a biaxially oriented film. When it is an unstretched film or uniaxially orientated film, it is difficult to obtain a uniform surface aspect, and even when a metal thin membrane is formed, it may become an appearance with poor metallic luster. Preferable production conditions for a biaxially oriented film will be described below.

Next, a specific production method of the polyester film for molded part is described. As a polyester resin, there can be used a generally commercial polyethylene terephthalate resin, polybutylene terephthalate resin, and copolymer thereof, for example, in the case of polyethylene terephthalate resin, it can be polymerized as follows.

To a mixture of 100 parts by mass of dimethyl terephthalate and 70 parts by mass of ethylene glycol, 0.09 parts by mass of magnesium acetate and 0.03 parts by mass of antimony trioxide are added, temperature is gradually raised, and ester exchange reaction is carried out while distilling off methanol finally at 220° C. Subsequently, after 0.020 parts by mass of 85% phosphoric acid aqueous solution is added to the product of ester exchange reaction, this is transferred to a vessel for polycondensation reaction. The reaction system is gradually reduced in pressure while raising temperature by heat in the condensation vessel, and polycondensation reaction is carried out at 290° C. under reduced pressure of 1 hPa, thereby producing a polyethylene terephthalate resin with a desired intrinsic viscosity, for example, with an intrinsic viscosity of 0.65.

For olybutylene terephthalate or polytrimethylene terephthalate, polymerization is possible in the same manner, for example, in the case of polybutylene terephthalate, a mixture of 100 parts by mass of terephthalic acid and 110 parts by mass of 1,4-butanediol is raised to 140° C. under nitrogen atmosphere to be converted into a uniform solution, then, 0.054 parts by mass of tetra-n-butyl orthotitanate and 0.054 parts by mass of monohydroxybutyltin oxide are added thereto to carry out esterification reaction. Subsequently, 0.066 parts by mass of tetra-n-butyl orthotitanate is added, and polycondensation reaction is carried out under reduced pressure, thereby producing a polybutylene terephthalate resin with a desired intrinsic viscosity, for example, with an intrinsic viscosity of 0.9.

Using the polyester resin thus obtained, a preferable method for producing a film will be specifically described.

First, a resin (A) of polyethylene terephthalate as well as a resin (B1) of polybutylene terephthalate and a resin (B2) of polytrimethylene terephthalate are weighted in a given ratio, and dried under nitrogen atmosphere or in vacuum before or after mixing. It is preferable to moisture percentage in a resin so as to be 50 ppm or less after drying. Then, the polyester resin mixed is melt extruded by being fed into a single screw or a twin screw extruder. Subsequently, after removing foreign materials and homogenizing each throughput rate by way of a filter and a gear pump, the resin is discharged in a sheet from a T-die onto a cooling drum. By an electrostatic method that a cooling drum and a resin are closely attached through static electricity by using electrodes loaded with high voltage; a casting method that water membrane is given to a casting drum and an extruded polymer sheet; a method that a casting drum temperature is set from glass transition temperature of polyester resin to (glass transition temperature—20° C.) to attach the extruded polymer thereon; or a method combined with a plurality of these methods, polymer of sheet shape is attached on a casting drum and solidified by cooling, thereby obtaining an unstretched film. Among these casting methods, an electrostatic method is preferably used from the viewpoints of productivity and flatness.

For a film, it is preferable to conduct stretching by successive biaxial stretching method that after an unstretched film is stretched in a machine-direction, the film is stretched in a transverse-direction, or after stretching in a transverse-direction, the film is stretched in a machine-direction; or by simultaneous biaxial stretching method that a film is stretched in the machine-direction and transverse-direction at the almost same time.

The stretching ratio in such stretching method is preferably adopted by 2.5 to 3.5 times in each direction, further preferably 2.8 to 3.5 times, and particularly preferably 3 to 3.4 times. Further, it is desirable that stretching speed by 1,000 to 200,000%/min. Further, stretching temperature is preferably 90 to 130° C., further preferably, it is preferable that stretching temperature in a machine-direction be 85 to 120° C. and stretching temperature in a transverse-direction be 80 to 120° C. Further, stretching may be carried out in each direction more than once. It is possible to suppress oriented crystallization in stretching and exhibit formability by dispersing a given amount of a resin (B) into a resin (A) and conducting heat treatment at a high temperature before stretching. A preferable heat treatment temperature herein is 90 to 130° C., 95 to 125° C. is further preferable, and 100 to 120° C. is most preferable.

Heat treatment of film is further conducted after a biaxial stretching. Heat treatment can be carried out by an arbitrary method conventionally known, in an oven, on a heated roll or the like. Regarding this heat treatment temperature, orientation is relaxed by operation at a high temperature to be able to improve formability. The heat treatment temperature is preferably adopted at 200 to 255° C., from the viewpoints of transparency and dimensional stability of a film, 210 to 250° C. is more preferable. Further, heat treatment time can be in an arbitrary range as long as not worsening characteristics, it is preferably 1 to 60 seconds, and more preferably, it is done for 1 to 30 seconds.

It is considered that a resin (B) is finely dispersed in an amorphous region of a resin (A) on the order of nanoscale. A high temperature treatment is very important because by heat treatment at a high temperature, the resin (B) melts and shows high mobility, and relaxation of an amorphous region of resin (A) occurs to exhibit formability.

Further, heat treatment may be carried out, by relaxing a film in a machine-direction and/or a transverse-direction.

Further, by conducting a high temperature treatment before stretching in the foregoing composition and conducting a high temperature treatment after stretching, fine dispersion of resin (B) in an amorphous region of resin (A) is promoted, and suppression of crystallization may lead to a ratio (DM) of a half bandwidth D (° C.) of a recrystallization peak in falling temperature in differential scanning calorimeter (DSC) to the peak height H (mW) being 3 to 150° C./mW.

Further, to improve adhesion forces to an ink-printing layer, an adhesive and a deposition layer, it is possible to conduct corona treatment on at least one surface or provide a coating layer.

The polyester film for molded part may be a lamination constitution of two-layer lamination of A/B, three-layer lamination of A/B/C or A/B/A, and further more than three layers.

For example, to provide windability of film, although lubricant particles are preferably added, since the added amount of particles is preferably as little as possible to maintain transparency, it is preferable that the particles be added to only one side layer if being a two-layer constitution. At least one surface of a film can be provided with lubricity, thereby both handleability and transparency can be satisfied. Further, if being three-layer constitution, by adding particles only to a surface layer, an excellent handleability can be provided and transparency can also be maintained.

Further, if being such laminated films, when composition of each layer differs largely and the recrystallization peak in falling temperature becomes double peaks or more, dimensional stability differs between laminated layers. Therefore, there is a case that slip is generated between layers by heating in thermoforming, and delamination tends to occur, thus, the kind of polyester resin used is preferably a similar composition in respective layers, and it is most preferable to be the same composition only with different concentrations of particles.

If producing a laminated film, layer thickness of a surface layer is preferably 0.1 to 10 μm from formability and appearance after forming. When the thickness of a surface layer is less than 0.1 μm, it is not preferable because a surface layer part tends to be broken, which tends to initiate delamination in the interface of layers, and interface delamination after forming may take place. On the other hand, when the thickness of a surface layer is more than 10 μm, it is not preferable because when concentration of particles is increased to provide handleability, transparency may deteriorate. The thickness of a surface layer is preferably 0.2 to 8 μm, and particularly preferably 0.5 to 5 μm. Further, if being three-layer lamination of A/B/C and A/B/A/, from an economical point of view, it is preferable that the lamination thickness of A layer be the same as that of C layer, and that the thickness of these surface layers be thinner than that of an inner layer.

Regarding the polyester film for molded part, haze of film is preferably 0.001 to 0.2%/μm from the points of appearance and luster as the molded part. When the haze is more than 0.2%/μm, the film looks white turbid in appearance, and it may be inferior in appearance and design. On the other hand, when the haze is less than 0.001%/μm, slippage of film is bad, handleability becomes difficult, scar is generated on a film surface and wrinkle tends to occur during winding a film up in a roll shape, not only causing adverse effects on appearance but also worsening the handleability of film itself. A preferable range of haze from appearance as the molded part is 0.005 to 0.15%/μm, and 0.01 to 0.13%/μm is particularly preferable.

As a method that haze is to be 0.001 to 0.2%/μm, it is a preferable method that lubricant particles are added only to A layer or B layer, and optical characteristics are controlled while maintaining handleability of film. Further, if producing a three-layer constitution of A/B/C, it is preferable to add particles only to A layer and C layer. In particular, when layer thickness of A layer is denoted as t_{A} (unit: μm), it is a preferable method that the particles whose circle-equivalent diameter P (unit: μm) of particles added to A layer satisfying a relationship of 0.5≦P/t_{A}≦2 are added in A layer by 0.005 to 0.06% by mass, and further preferably 0.005 to 0.03% by mass. The lubricant particles used are not particularly limited, but it is preferable to use additional particles rather than internal particles. As the additional particles, for example, there can be used wet type and dry type silica, colloidal silica, aluminum silicate, titanium oxide, calcium carbonate, calcium phosphate, barium sulfate and aluminum oxide, particles including styrene, silicone, acrylic acids, methacrylic acids, polyesters, divinyl compounds or the like as constituents, or organic particles. Among them, it is preferable to use inorganic particles such as wet type and dry type silica and alumina, particles including styrene, silicone, acrylic acid, methacrylic acid, polyester, divinyl benzene or the like as constituents. Further, these additional particles may be in concomitant use of 2 kinds or more thereof.

Further, in a case where the polyester film for molded part is provided with a coating layer, it is a preferable method of being provided inline in a film production process, for example, it is a preferable method that on a film that at least uniaxial stretching is carried out, one that a coating layer composition has been dispersed in water is uniformly coated by using a metering bar, gravure roll or the like, and the coating liquid is dried while stretching the film. The thickness of the coating layer is herein preferably 0.01 to 0.5 μm.

Since the polyester film for molded part aims to be used as molded parts, when film thickness after molding becomes less than 10 μM, it may be inferior in shape retention. Therefore, film thickness before molding is preferably 15 to 250 μm. When film thickness exceeds 250 μm, even if strain stress is lowered in thermoforming, actual load becomes large, thus the film may be deformed unevenly and productivity may be lowered due to taking time to raise temperature for processing. Further, a preferable film thickness is 18 to 100 μm, and 20 to 50 μm is particularly preferable.

Regarding the polyester film for molded part, it is preferable that a metal compound be deposited on at least one surface of a film for use. By using a film deposited with a metal compound, appearance becomes metallic, the film can be preferably used as an alternative product of molded parts that plated resins are used at present. It is more preferable that a metal compound with a melting point of 150 to 400° C. be deposited for use. Using a metal in such melting point range is preferable because the metal-deposited layer can be processed in a formable temperature region of polyester film, and generation of defects in the deposited layer by forming is easily suppressed. A particularly preferable melting point of a metal compound is 150 to 300° C. The metal compound with a melting point of 150 to 400° C. is not particularly limited, indium (157° C.) and tin (232° C.) are preferable, and indium can be preferably used particularly from the points of metallic luster and color tone.

Further, as a production method for a thin deposition membrane, there can be used vacuum deposition, electron-beam deposition, sputtering, ion plating and the like. Additionally, to improve adhesion between a polyester film and a deposition layer, pretreatment may be carried out by a method such as corona discharge treatment and coating an anchor coating agent on a film surface beforehand. Further, the thickness of the deposition membrane is preferably 1 to 500 nm, and more preferably 3 to 300 nm. It is preferably 3 to 200 nm from the point of productivity.

Regarding the polyester film for molded part, from the viewpoint of quality maintenance for use in outdoor environments, it is preferable to provide a coating layer of weather resistance on at least one surface of a film. As a method for providing a coating layer, it is not only the foregoing inline coating in a film forming process, but also offline coating may be used. When the thickness of the coating layer needs 1 μm or more, it is preferable from the point of productivity to conduct coating offline. The coating agent used in a coating layer of weather resistance is not particularly limited, as a solvent used for coating, a composition capable of using water is preferable.

Further, the polyester film for molded part is preferably used by being laminated on a formable decorative sheet. This is preferable because after lamination on the surface of the formable decorative sheet, these are molded as being integrated, thus scar on surface after molding a decorative sheet and the lowering of gloss can be suppressed.

The constitution of a formable decorative sheet is not particularly limited, but a constitution that a decorative layer is laminated on a base sheet is preferable. Further, to provide weather resistance and scar resistance on a decorative layer, it is a preferable aspect to laminate a clear layer thereon. Further, the constitution that a clear layer is directly laminated on a base sheet is a preferable constitution because of leading to a value as a decorative sheet.

The base material for a formable decorative sheet is not particularly limited, there are listed a resin sheet, metal sheet, paper, wood and the like. Among them, a resin sheet is preferably used from the point of formability, and a thermoplastic resin sheet is preferably used from the point of high, formability.

As a thermoplastic resin sheet, it is not particularly limited as long as it is a thermo-formable polymer sheet, there are preferably used an ABS (Acrylnitrile-butadiene-styrene) sheet, polystyrene sheet, AS (Acrylnitrile-styrene) sheet, TPO (Thermo Plastic Olefin elastomer) sheet, TPU (Thermo Plastic Urethane elastomer) and the like. Thickness of the sheet is 50 μm to 2000 μm, more preferably 100 μm to 1500 μm, and further preferably 150 μm to 1000 μM.

Further, as a resin used as a clear layer, it is not particularly limited as long as it is a highly transparent resin, there are preferably used a polyester type resin, polyolefin type resin, acryl type resin, urethane type resin, fluorine type resin and the like. Among them, one containing a fluorine type resin is preferable from the point of weather resistance. Further, it may be a mixture of these resins. For example, poly(vinylidene fluoride) dispersion liquid dispersed in polymethyl methacrylate is preferably used. Further, lamination thickness of a clear layer is, from the viewpoints of weather resistance and handleability, preferably 10 to 100 μm, further preferably 15 to 80 μm, and most preferably 20 to 60 μm.

A decorative layer used in a formable decorative sheet is a layer to provide decoration such as coloring, convex and concave, pattern, wood grain, metallic tone and pearl tone, and decorates a molded article finally when a molded article is produced using a formable decorative sheet. A layer in which a coloring agent is compounded in printing or resin, and a metal-deposited layer are listed, but it is not limited thereto.

Further, a method for forming a decorative layer is not particularly limited, for example, it can be formed by printing, coat, transfer, metal deposition or the like. Examples of particularly preferable method for forming a decorative layer include a method where one that a coloring agent was dispersed in a resin is coated on a carrier film, which is transferred to a base material. Examples of resins used herein include a polyester type resin, polyolefin type resin, acryl type resin, urethane type resin, fluorine type resin and the like. As a coloring agent used, but not particularly limited, from consideration of dispersibility etc., it is suitably chosen from dye, inorganic pigment, organic pigment and the like. As a dispersion resin, as in the clear layer, for example, poly(vinylidene fluoride) dispersion liquid dispersed in polymethyl methacrylate is preferably used.

Further, in the case of metal deposition, a production method for a thin deposition membrane is not particularly limited, there can be used vacuum deposition, electron-beam deposition, sputtering, ion plating and the like. To improve adhesion between a polyester film and a deposition layer, it is desirable that pretreatment be carried out by a method such as corona discharge treatment and coating an anchor coating agent on a deposition surface beforehand. As a metal used, from the point of molding following, it is preferable that a metal compound with a melting point of 150 to 400° C. be deposited for use. Using a metal of the melting point range is preferable because the metal-deposited layer can be processed in a formable temperature region of polyester film and generation of defects in the deposited layer by molding is easily suppressed. A more preferable melting point of a metal compound is 150 to 300° C. The metal, compound with a melting point of 150 to 400° C. is not particularly limited, indium (157° C.) and tin (232° C.) are preferable, in particular, indium can be preferably used. The lamination thickness of a decorative layer is preferably 0.001 to 100 μm, more preferably 0.01 to 80 μm, and most preferably 0.02 to 60 μm.

The disposing method of a clear layer is not particularly limited, a method of transfer on a thermoplastic sheet (base material) by using a carrier film is preferable. After a resin for a clear layer is laminated on a carrier film and dried, it is possible to transfer on a thermoplastic sheet (base material). Further, in disposing a decorative layer, after laminating a decorative layer on a clear layer, a decorative layer/clear layer can be transferred on a thermoplastic sheet (base material). A carrier film used herein is not particularly limited, during laminating a clear layer or a clear layer/decorative layer, it may be heated at about 100 to 200° C. for drying, and a film with excellent heat resistance is thus preferable. From the viewpoints of heat resistance and economic efficiency, there are preferably used polyester films such as polyethylene terephthalate film and polyethylene naphthalate film, or a copolyester film containing a copolymerizable component therein.

Further, to improve adhesion with a thermoplastic sheet (base material), it is preferable to dispose an adhesive layer on a clear layer or a decorative layer. As an adhesive layer, it is not particularly limited, one that a crosslinker is added to a urethane type, acryl type, or polypropylene chloride is preferably used. As the crosslinker, epoxy type is preferably used from the point of adhesion. Further, to improve an adhesion force between a decorative layer and an adhesive layer, it is also preferable to provide a primer layer of acryl type resin or the like.

As described above, the polyester film for molded part is preferably used by being laminated on the surface of a decorative sheet, and a method, in which a clear layer or a decorative/clear layer is laminated on a thermoplastic resin sheet (base material) by using the film as a carrier film, it is then held while being layered on the clear layer as it is, and used as, a protection film without modification during molding a formable decorative sheet (carrier film acts as a protection film as it is), is very preferable because an economic effect due to simplification of production process of molded article becomes large.

A method for producing a formable laminate where the polyester film for molded part is laminated on a formable decorative sheet will be described specifically. The methods are not limited thereto.

Poly(vinylidene fluoride) dispersion liquid dispersed in polymethyl methacrylate is die-coated on a polyethylene terephthalate carrier film by a die-coat, a clear layer is laminated thereon and dried. Further, one that a coloring agent is dispersed is laminated in the poly(vinylidene fluoride) dispersion liquid dispersed in polymethyl methacrylate by a die-coat method, and dried, thereby producing a constitution of carrier film/clear layer/decorative layer. On the decorative layer of the constitution, an acryl type polymer as a primer layer is laminated, and a urethane resin/epoxy type crosslinker as an adhesive layer is laminated. The thus obtained constitution of carrier film/clear layer/decorative layer/primer layer/adhesive layer is attached via an adhesive layer on a TPO sheet whose surface is corona-treated. Thereafter, peeling the carrier film leads to a formable decorative sheet having a constitution of TPO sheet/adhesive layer/decorative layer/clear layer. Further, a polyester film for molded part is hot-pressure bonded on this formable decorative sheet, thereby producing a formable laminate that a polyester film for molded part is laminated on a formable decorative sheet.

Next, a molding method of this formable laminate will be explained specifically, but the molding method is not limited thereto.

A formable laminate is heated so as to be the surface temperature to 30 to 200° C. by using a far-infrared heater of 150 to 400° C., a metal mold is pushed up and vacuumed to mold a desired shape. If molding with a severe magnification, a deeper molding becomes possible by molding with further pneumatic operation to a sheet. The formable laminate thus molded is trimmed to become a molded article that a polyester film for molded part is laminated as a protection film thereon. Further, this molded article may be use as it is, to provide strength as a molded product, a TPO resin may be injected in a concave part while pushing a metal mold. By peeling the polyester film for molded part from the molded article thus molded, a molded part is achieved.

The molded part thus obtained is high in gloss, and defects such as scar on surface, deformation and undulation are hardly observed therein while indicating a very excellent appearance, thus preferably used as building materials, automobile parts and parts of cellular phone, electric goods and the like.

As described above, regarding the resulting molded part, an absolute value of difference in gloss between the part and a formable laminate before molding can be less than 10. When the absolute value of difference in gloss is less than 10, it is preferable because no large difference is observed before and after molding upon luster evaluation by eye, and shininess designed before molding can be maintained. The absolute value of difference in gloss between the part and a formable laminate before molding is more preferably less than 5, and most preferably less than 3.

Further, the polyester film for molded part may be recovered after being peeled from a molded article and used again. Further, it is very preferable economically and environmentally to melt the recovered film for palletizing again as a recovered raw material, and use as a raw material for forming film.

The polyester film for molded part has an excellent processability and can easily produce a molded part compliant with a mold in thermoforming such as vacuum or pressure forming. Therefore, by previously providing metal deposition before molding, it can be used suitably in automobile parts and parts for home appliance as molded parts having a plating-like appearance, further can be used as a surface protection film upon molding a decorative sheet, and appearance of molded part becomes beautiful, so that a completed molded article is preferably used as building materials, automobile parts and parts of cellular phone, electric goods and the like.

### EXAMPLES

Hereinafter, our structures and methods will be explained in detail by Examples. Characteristics have been evaluated by the following methods.

### (1) Heat Characteristic of Film

Five mg of a film was taken in an aluminum pan as a sample, and measured with a differential scanning calorimeter (DSC; RDC220 manufactured by Seiko Electric Co., Ltd.). First, an endotherm peak in raising temperature from 25° C. to 280° C. at 20° C./min under nitrogen atmosphere was defined as a melting point. Next, it was held at 280° C. for 1 minute, and then measured in falling temperature to 25° C. at 20° C./min. An exoergic peak in this time was defined as a recrystallization peak, and the temperature of the peak top P was defined as a recrystallization temperature Tmc (° C.). Further, a base line L was drawn based on a plane part at the high temperature side of this exoergic peak, a height parallel to a vertical axis from the base line L to the peak top P is defined as a peak height H (mW), peak width parallel to the base line L at 0.5 H of the peak height is defined as a half bandwidth D (° C.), and D/H was calculated from the peak height H and half bandwidth D.

### (2) Intrinsic Viscosity of Polyester

The intrinsic viscosities of polyester resin and film were measured at 25° C. by dissolving polyester in ortho-chlorophenol and using Ostwald viscometer.

### (3) Composition of Polyester

A resin or film is dissolved in hexafluoroisopropanol (HFIP) or a mixed solvent of HFIP and chloroform, and the content of each monomer residue and diethylene glycol being by-product can be measured using ¹H-NMR and ¹³C-NMR. In the case of a laminated film, depending on lamination thickness, each layer of the film is scraped off to take a component constituting each layer, by which evaluation can be done. For a film, the composition was determined by calculation of mixing ratio upon film production.

### (4) Density

A sample cut to a square (3 mm×3 mm) was immersed overnight in a density gradient tube (aqueous NaBr solution, 25° C.) and evaluation was conducted by reading graduation of the gradient tube. Four floats having known density were put in the density gradient tube, and a calibration curve of gradient was previously prepared by the graduations of the floats, and density of each sample was calculated on the basis of the calibration curve. Each sample was put therein every three pieces and the average value was adopted.

### (5) Formability

A film was cut to rectangular shape of 150 mm (in length)×10 mm (in width) in a machine-direction and a transverse-direction for a sample. Using a tensile testing machine (Ten-siron UCT-100 manufactured by Orientec., LTD), tensile tests in a machine-direction and a transverse-direction respectively were conducted at an initial chuck distance of 50 mm and a tensile speed of 300 mm/min. For the measurement, the sample was set in a constant temperature oven previously set at 190° C., and the tensile test was conducted after preheating for 30 seconds. A load on the film loaded when the sample was elongated by 100% (distance between chucks became 100 mm) was read, value obtained by dividing the load by a cross section area of a sample before test (film thickness×10 mm) was defined as a stress at 100% elongation (F100 value), and evaluation was conducted by the F100 value. The measurements were repeated 5 times for each sample in each direction, and the average was adopted.

### Evaluation 1

On the basis of each measuring result, evaluation was done by the following criteria:
S grade: F100 values in both machine-direction and transverse-direction of film were less than 10 MPa.
A grade: F100 value either in a machine-direction or transverse-direction of film was less than 10 MPa and the other was 10 to 20 MPa.
B grade: F100 values in both machine-direction and transverse-direction of film were 10 to 20 MPa.
C grade: F100 value either in a machine-direction or transverse-direction of film was 20 MPa or more.

### Evaluation 2

By emphasizing the balance between the machine-direction and transverse-direction, evaluation was done by the following criteria:
S grade: Absolute value of difference of F100 values in the machine-direction and transverse-direction of film was less than 3 MPa.
A grade: Absolute value of difference of F100 values in the machine-direction and transverse-direction of film was 3 to less than 5 MPa.
B grade: Absolute value of difference of F100 values in the machine-direction and transverse-direction of film was 5 to less than 10 MPa.
C grade: Absolute value of difference of F100 values in the machine-direction and transverse-direction of film was 10 MPa or more.

### (6) Metallic Appearance

On one surface of a film, plasma treatment (electrode: stainless steel, power: 0.5 kW, atmosphere: oxygen) was conducted, continuously, sputtering treatment was conducted using indium as a target, and a metallic film that a deposition layer in which an indium layer thickness was 100 to 120 nm was formed was produced. The metallic film was cut to A4 size, the ten films were laid side-by-side and observed by eye from a nonmetallic layer side, and determination was done by the following criteria:
S grade: Appearance was uniform with metal luster.
A grade: Luster was lost in a case of observation from some angles.
B grade: Surface was partly rough, luster was somewhat lost, but problem-free level.
C grade: Surface was rough due to heat load and no metallic luster was observed.

### (7) Characteristic as Protection Film

Poly(vinylidene fluoride) dispersion liquid dispersed in polymethyl methacrylate by 10% by mass was die-coated on a polyethylene terephthalate carrier film (50 μm) by die-coat, a clear layer was laminated, and dried at 200° C. for 10 seconds. Further, as a primer layer, an acrylate type polymer (68070 produced by DuPont) was dispersed in toluene by 30% by mass, and coated on the clear film by a gravure roll, further, as an adhesive layer, an adhesive mixed with an adhesive agent AD503, curing agent CAT10 produced by Toyo Morton Inc. and ethyl acetate by 20:1:20 (weight ratio) was coated thereon. The carrier obtained by such method was, after subjecting a surface of a TPO sheet to corona treatment, attached thereon via the adhesive layer, thereby providing a decorative sheet constituted by TPO sheet/adhesive layer/clear layer by peeling the carrier film. Further, a polyester film for molded part was hot-pressure bonded on this decorative sheet (150° C., 0.3 MPa, 10 m/min) and laminated, thereby producing a formable laminate that a polyester film for molded part was used. The formable laminate was heated so as to be the surface temperature to be 150° C. by using a far-infrared heater of 400° C., and vacuum molding was conducted along a cylindrical mold (bottom face diameter 50 mm) heated at 40° C. Thereafter, the polyester film for molded part was peeled to produce a molded part, a state molded along the mold was evaluated for degree of molding (drawing ratio: molding height/bottom face diameter). Further, in accordance with a method specified by JIS-Z-8741 (year 1997), using a digital varied-angle gloss meter UGV-5D manufactured by Suga Test Instruments Co., Ltd., surfaces of the decorative sheet before molding and molded part after molding were measured for 60° specular gloss, and the difference in gloss before and after molding was evaluated. The measurement of gloss was herein done by n=5, and an average value after removing the maximum and minimum was adopted. As described above, characteristics as a protection film from the degree of molding and gloss were evaluated by the following criteria:
S grade: It was able to be molded with a drawing ratio of 0.7 or more, the absolute value of difference in gloss between the resulting molded article and formable laminate before molding was less than 3.
A grade: It was able to be molded with a drawing ratio of 0.7 or more, the absolute value of difference in gloss between the resulting molded article and formable laminate before molding was 3 to 5.
B grade: It was able to be molded with a drawing ratio of 0.3 to 0.7, the absolute value of difference in gloss between the resulting molded article and formable laminate before molding was less than 10.
C grade: Shape with a drawing ratio of 0.3 was not able to be molded.

### Example 1

A polyethylene terephthalate resin (resin (A)) with an intrinsic viscosity of 0.65 (containing 0.1% by mass of spherical silica particles having an average particle diameter of 1 μm), a polybutylene terephthalate resin (resin (B1)) with an intrinsic viscosity of 1.2 and a polytrimethylene terephthalate resin (resin (B2)) with an intrinsic viscosity of 0.9 were mixed by 7:1.5:1.5 in mass ratio (resin (A):resin (B) was 7:3), then dried in vacuum at 180° C. for 4 hours. The resin after drying was fed to a 90 mmφ single screw extruder (full flight screw with L/D=28 and compression ratio of 4.0) and melt extruded at 280° C. in cylinder and polymer tube temperatures. The resin temperature at the front edge of the extruder was measured to be 274° C. After the resin was loaded into the extruder, in a residence time of 15 minutes, the melt resin was discharged from a T-die, cooled and solidified on a cooling drum controlled at a temperature of 25° C. while being attached thereon by electrostatic, thereby obtaining an unstretched film. Subsequently, before stretching in a machine-direction, temperature of the film was raised by heating rolls, the film was stretched finally at the film temperature of 105° C. for 3.1 times in a machine-direction, subsequently, using a tenter type transverse drawing machine, stretched at a preheat temperature of 80° C. and a stretching temperature of 100° C. for 3.0 times in a width direction, and heat-treated at 245° C. for 5 seconds while relaxing by 6% in a transverse-direction in the tenter as it is, thereby obtaining a biaxially oriented film of 25 μm in film thickness.

### Example 2

A polyethylene terephthalate resin (resin (A)) with an intrinsic viscosity or 0.65 (containing 0.2% by mass of spherical silica particles having an average particle diameter of 1 μm), a polybutylene terephthalate resin (resin (B1)) with an intrinsic viscosity of 1.2 and a polytrimethylene terephthalate resin (resin (B2)) with an intrinsic viscosity of 0.9 were mixed by 8:1:1 in mass ratio (resin (A):resin (B) was 8:2), and then dried in vacuum at 180° C. for 4 hours. The resin after drying was fed to a 45 mmφ twin screw extruder (L/D=45) and kneaded at a cylinder temperature of 275° C. The melt was extruded into strands from discharge apertures equipped at the front edge of a cylinder, cooled and solidified in a water bath, cut to a pellet shape by a cutter, thereby producing mixed-resin chips. The mixed-resin chips were dried in vacuum at 180° C. for 4 hours, then fed to a 65 mmφ single screw extruder (full flight screw with L/D=28 and compression ratio of 4) and melt extruded at 285° C. in cylinder and polymer tube temperatures. The resin temperature at the front edge of the extruder was measured to be 277° C. After the resin was loaded into the extruder, in a residence time of 20 minutes, the melt resin was discharged from a T-die, cooled and solidified on a cooling drum controlled at a temperature of 25° C. while being attached thereon by electrostatic; thereby obtaining an unstretched film. Subsequently, before stretching in a machine-direction, temperature of the film was raised by heating rolls, the film was stretched finally at the film temperature of 100° C. for 3.15 times in a longitudinal direction, subsequently, using a tenter type transverse drawing machine, stretched at a preheat temperature of 80° C. and a stretching temperature of 100° C. for 3.0 times in a width direction, and heat-treated at 240° C. for 5 seconds while relaxing by 6% in a transverse-direction in the tenter as it is, thereby obtaining a biaxially oriented film of 25 μM in film thickness.

### Example 3

A polyethylene terephthalate resin (resin (A)) with an intrinsic viscosity of 0.62 (containing 1% by mass of spherical silica particles having an average particle diameter of 1.5 μm), a polybutylene terephthalate resin (resin (B1)) with an intrinsic viscosity of 1.0 and a polytrimethylene terephthalate resin (resin (B2)) with an intrinsic viscosity of 0.9 were mixed by 9.0:0.7:0.3 in mass ratio (resin (A):resin (B) was 9:1) and used. The resin was fed to a 45 mmφ twin screw extruder (L/D=45) and kneaded at a cylinder temperature of 280° C. The resin was extruded into strands from discharge apertures equipped at the front edge of a cylinder, cooled and solidified in a water bath, cut to a pellet shape by a cutter, thereby producing mixed-resin chips. Thereafter, a biaxially oriented film of 25 μm in thickness was obtained in the same manner as in Example 2 except that melt extrusion was conducted at 280° C. in cylinder and polymer tube temperatures (residence time: 23 minutes, resin temperature of 273° C.).

### Example 4

A polyethylene terephthalate resin (resin (A)) with an intrinsic viscosity of 0.65 (containing 0.5% by mass of spherical silica particles having an average particle diameter off 1 μm), a polybutylene terephthalate resin (resin (B1)) with an intrinsic viscosity of 1.2 and a polytrimethylene terephthalate resin (resin (B2)) with an intrinsic viscosity of 0.9 were mixed by 7:1:2 in mass ratio (resin (A):resin (B) was 7:3) and used. The resin was fed to a 45 mmφ twin screw extruder (L/D=45) and kneaded at a cylinder temperature of 275° C. The resin was extruded into strands from discharge apertures equipped at the front edge of a cylinder, cooled and solidified in a water bath, cut to a pellet shape by a cutter, thereby producing mixed-resin chips. Thereafter, forming a film of a biaxially oriented film was carried out to obtain a film of 25 μm in the same manner as in Example 2 except that melt extrusion was conducted at 280° C. in cylinder and polymer tube temperatures (residence time: 23 minutes, resin temperature of 276° C.).

### Example 5

A polyethylene terephthalate resin (resin (A)) with an intrinsic viscosity of 0.65 (containing 0.1% by mass of spherical silica particles having an average particle diameter of 1 μm), a polybutylene terephthalate resin (resin (B1)) with an intrinsic viscosity of 0.9 and a polytrimethylene terephthalate resin (resin (B2)) with an intrinsic viscosity of 0.9 were mixed by 7:0.5:2.5 in mass ratio (resin (A):resin (B) was 7:3) and used. The resin was fed to a 45 mmφtwin screw extruder (L/D=45) and kneaded at a cylinder temperature of 280° C. The resin was extruded into strands from discharge apertures equipped at the front edge of a cylinder, cooled and solidified in a water bath, cut to a pellet shape by a cutter, thereby producing mixed-resin chips. Thereafter, a biaxially oriented film of 25 μm in thickness was obtained in the same manner as in Example 2 except that melt extrusion was conducted at 285° C. in cylinder and polymer tube temperatures (residence time: 25 minutes, resin temperature of 279° C.).

### Example 6

A polyethylene terephthalate resin (resin (A)) with an intrinsic viscosity of 0.72 obtained by carrying out solid phase polymerization (containing 0.1% by mass of spherical silica particles having an average particle diameter of 1.2 μm), a polybutylene terephthalate resin (resin (B1)) with an intrinsic viscosity of 1.2 and a polytrimethylene terephthalate resin (resin (B2)) with an intrinsic viscosity of 0.9 were mixed by 6:3.5:0.5 in mass ratio (resin (A):resin (B) was 6:4) and used, the resin was fed to a 45 mmφ single screw extruder (full flight screw with L/D=28 and compression ratio of 3.6) and melt extrusion was conducted at 275° C. in cylinder and polymer tube temperatures. The resin temperature at the front edge of the extruder was measured to be 268° C. Forming film was carried out in the same manner as in Example 1 to obtain a biaxially oriented film of 25 μm except that after the resin was loaded into the extruder, in a residence time of 15 minutes, the melt resin was discharged from a T-die and the heat treatment temperature was set to 235° C.

### Example 7

A polyethylene terephthalate resin (resin (A)) with an intrinsic viscosity of 0.65 (containing 0.1% by mass of spherical silica particles having an average particle diameter of 1 μm), a polybutylene terephthalate resin (resin (B1)) with an intrinsic viscosity of 0.7 and a polytrimethylene terephthalate resin (resin (B2)) with an intrinsic viscosity of 0.9 were mixed by 7:2.5:0.5 in mass ratio (resin (A):resin (B) was 7:3) and used. Thereafter, a biaxially oriented film of 25 μm in thickness was obtained in the same manner as in Example 1.

### Example 8

A polyethylene terephthalate resin (resin (A)) with an intrinsic viscosity of 0.65 (containing 0.4% by mass of spherical silica particles having an average particle diameter of 1 μm), a polybutylene terephthalate resin (resin (B1)) with an intrinsic viscosity of 1.2 and a polytrimethylene terephthalate resin (resin (B2)) with an intrinsic viscosity of 0.9 were mixed by 8:1.5:0.5 in mass ratio (resin (A):resin (B) was 8:2) and used. Thereafter, a biaxially oriented film of 25 μm in thickness was obtained in the same manner as in Example 1.

### Example 9

A polyethylene terephthalate resin (resin (A)) with an intrinsic viscosity of 0.65 (containing 2% by mass of spherical silica particles having an average particle diameter of 1 μm), a polybutylene terephthalate resin (resin (B1)) with an intrinsic viscosity of 1.75 and a polytrimethylene terephthalate resin (resin (B2)) with an intrinsic viscosity of 0.9 were mixed by 7.5:2:0.5 in mass ratio (resin (A):resin (B) was 7.5:2.5) and used. Thereafter, a biaxially oriented film of 25 μm in thickness was obtained in the same manner as in Example 1.

### Example 10

A polyethylene terephthalate resin (resin (A)) with an intrinsic viscosity of 0.65 (containing 0.4% by mass of spherical silica particles having an average particle diameter of 1 μm), a polybutylene terephthalate resin (resin (B1)) with an intrinsic viscosity of 0.9 and a polytrimethylene terephthalate resin (resin (B2)) with an intrinsic viscosity of 1.0 were mixed by 7.5:0.5:2 in mass ratio (resin (A):resin (B) was 7.5:2.5) and used. The resin was fed to a 45 mmφ twin screw extruder (L/D=45) and kneaded at a cylinder temperature of 280° C. The resin was extruded into strands from discharge apertures equipped at the front edge of a cylinder, cooled and solidified in a water bath, cut to a pellet shape by a cutter, thereby producing mixed-resin chips. Thereafter, a biaxially oriented film of 30 μm in thickness was obtained in the same manner as in Example 2 except that melt extrusion was conducted at 280° C. in cylinder and polymer tube temperatures (residence time: 21 minutes, resin temperature of 274° C.).

### Example 11

A polyethylene terephthalate resin (resin (A)) with an intrinsic viscosity of 0.65 (containing 0.4% by mass of spherical silica particles having an average particle diameter of 1 μm), a polybutylene terephthalate resin (resin (B1)) with an intrinsic viscosity of 1.75 and a polytrimethylene terephthalate resin (resin (B2)) with an intrinsic viscosity of 0.9 were mixed by 5:4:1 in mass ratio (resin (A):resin (B) was 5:5) and used. Thereafter, a biaxially oriented film of 25 μm in thickness was obtained in the same manner as in Example 1.

### Comparative Example 1

A polyethylene terephthalate resin (resin (A)) with an intrinsic viscosity of 0.65 (containing 0.1% by mass of spherical silica particles having an average particle diameter of 1 μm), a polybutylene terephthalate resin (resin (B1)) with an intrinsic viscosity of 1.2 and a polytrimethylene terephthalate resin (resin (B2)) with an intrinsic viscosity of 1.0 were mixed by 8:1.5:0.5 in mass ratio (resin (A):resin (B) was 8:2) for use, then dried in vacuum at 180° C. for 4 hours. The resin after drying was fed to a 90 mmφ single screw extruder (full flight screw with L/D=28 and compression ratio of 3.8) and melt extruded at 275° C. in cylinder and polymer tube temperatures. The resin temperature at the front edge of the extruder was measured to be 268° C. After the resin was loaded into the extruder, in a residence time of 10 minutes, the melt resin was discharged from a T-die, cooled and solidified on a cooling drum controlled at a temperature of 25° C. while being attached thereon by electrostatic, thereby obtaining an unstretched film. Subsequently, before stretching in a machine-direction, temperature of the film was raised by heating rolls, the film was stretched finally at the film temperature of 95° C. for 3.15 times in a machine-direction, subsequently, using a tenter type transverse drawing machine, stretched at a preheat temperature of 80° C. and a stretching temperature of 90° C. for 3.0 times in a transverse-direction, and heat-treated at 235° C. for 5 seconds while relaxing by 6% in a width direction in the tenter as it is, thereby obtaining a biaxially oriented film of 25 μm in film thickness.

### Comparative Example 2

A biaxially oriented film of 25 μm in thickness was obtained by forming film in the same manner as in Comparative Example 1 except that a polyethylene terephthalate resin (resin (A)) with an intrinsic viscosity of 0.72 obtained by carrying out solid phase polymerization, a polybutylene terephthalate resin (resin (B1)) with an intrinsic viscosity of 1.2 and a polytrimethylene terephthalate resin (resin (B2)) with an intrinsic viscosity of 0.9 were mixed by 3:6.5:0.5 in mass ratio (resin (A):resin (B) was 3:7), and dried in vacuum at 180° C. for 4 hours, then fed to a 90 mmφ single screw extruder (L/D=32 and compression ratio of 3.2) and melt extrusion was conducted at 265° C.

### Comparative Example 3

A polyethylene terephthalate resin (resin (A)) with an intrinsic viscosity of 0.62 (containing 0.1% by mass of spherical silica particles having an average particle diameter of 1.5 μm), a polybutylene terephthalate resin (resin (B1)) with an intrinsic viscosity of 1.2 and a polytrimethylene terephthalate resin (resin (B2)) with an intrinsic viscosity of 0.9 were mixed by 9:0.5:0.5 in mass ratio (resin (A):resin (B) was 9:1) and used, melt extrusion and biaxial stretching were conducted in the same conditions as in Comparative Example 1, and a biaxially oriented film of 25 μm in thickness was obtained.

### Comparative Example 4

A polyethylene terephthalate resin (resin (A)) with an intrinsic viscosity of 0.65 (containing 0.2% by mass of condensed silica particles having an average particle diameter of 2.4 μm), a polybutylene terephthalate resin (resin (B1)) with an intrinsic viscosity of 1.2 and a polytrimethylene terephthalate resin (resin (B2)) with an intrinsic viscosity of 0.9 were mixed by 6:1.5:2.5 in mass ratio (resin (A):resin (B) was 6:4) and used. The resin was fed to a 45 mmφ twin screw extruder (L/D=45) and kneaded at a cylinder temperature of 280° C. The resin was extruded into strands from discharge apertures equipped at the front edge of a cylinder, cooled and solidified in a water bath, cut to a pellet shape by a cutter, thereby producing mixed-resin chips. Thereafter, a biaxially oriented film of 25 μm in thickness was obtained in the same manner as in Example 2 except that melt extrusion was conducted at 285° C. in cylinder and polymer tube temperatures (residence time: 25 minutes, resin temperature of 281° C.).

### Comparative Example 5

A polyethylene terephthalate resin (resin (A)) with an intrinsic viscosity of 0.65 (containing 0.08% by mass of spherical silica particles having an average particle diameter of 1.5 μm) and a polybutylene terephthalate resin (resin (B)) with an intrinsic viscosity of 1.95 were mixed by 7:3 in mass ratio and used. Thereafter, a biaxially oriented film of 25 μm in thickness was obtained in the same manner as in Example 1.

### Comparative Example 6

A polyethylene terephthalate resin (resin (A)) with an intrinsic viscosity of 0.65 (containing 0.1% by mass of spherical silica particles having an average particle diameter of 1 μm), a polybutylene terephthalate resin (resin (B1)) with an intrinsic viscosity of 1.2 and a polytrimethylene terephthalate resin (resin (B2)) with an intrinsic viscosity of 0.9 were mixed by 9.5:0.1:0.4 in mass ratio (resin (A):resin (B) was 9.5:0.5) and used. The resin was fed to a 45 mmφ twin screw extruder (L/D=45) and kneaded at a cylinder temperature of 280° C. The resin was extruded into strands from discharge apertures equipped at the front edge of a cylinder, cooled and solidified in a water bath, cut to a pellet shape by a cutter, thereby producing mixed-resin chips. Thereafter, a biaxially oriented film of 25 μm in thickness was obtained in the same manner as in Example 2 except that melt extrusion was conducted at 285° C. in cylinder and polymer tube temperatures (residence time: 25 minutes, resin temperature of 278° C.).

### Comparative Example 7

A polyethylene terephthalate resin (resin (A)) with an intrinsic viscosity of 0.65 (containing 0.2% by mass of spherical silica particles having an average particle diameter of 1.5 μm) and a polybutylene terephthalate resin (resin (B)) with an intrinsic viscosity of 1.2 were mixed by 0.8:9.2 in mass ratio and used, then dried in vacuum at 180° C. for 4 hours. The resin after drying was fed to a 90 mmφ single screw extruder (full flight screw with L/D=28 and compression ratio of 4.0) and melt extruded at 265° C. in cylinder and polymer tube temperatures. The resin temperature at the front edge of the extruder was measured to be 260° C. After the resin was loaded into the extruder, in a residence time of 15 minutes, the melt resin was discharged from a T-die, cooled and solidified on a cooling drum controlled at a temperature of 25° C. while being attached thereon by electrostatic, thereby obtaining an unstretched film. The resulting unstretched film was already crystallized, so that stretching was not able to carry out, and no biaxially oriented film was obtained.

TABLE 1

| | | | Example 1 | Example 2 | Example 3 | Example 4 |
|---|---|---|---|---|---|---|
| Mixing ratio | Resin (A) (% by mass) | | 70 | 80 | 90 | 70 |
| | Resin (B) | (% by mass) | 30 | 20 | 10 | 30 |
| | | Resin (B1) (% by | 15 | 10 | 7 | 10 |
| | | mass) | | | | |
| | | Resin (B2) (% by | 15 | 10 | 3 | 20 |
| | | mass) | | | | |

| Heat characteristic | D/H (° C./mW) | 72 | 65 | 3.4 | 114 |
|---|---|---|---|---|---|
| | Tmc (° C.) | 151 | 155 | 210 | 136 |
| | Number of melting | 1 | 1 | 1 | 1 |
| | peaks in raising | | | | |
| | temperature | | | | |
| Density (g/cm³) | | 1.3592 | 1.3739 | 1.3892 | 1.3661 |
| Formability | F100MD (MPa) | 4.7 | 9.4 | 16.6 | 7.4 |
| | F100TD (MPa) | 6.6 | 12.3 | 19.8 | 8.3 |
| | Evaluation | S/S | A/S | B/A | S/S |
| | 1/Evaluation 2 | | | | |
| Appearance | Evaluation | S | S | S | A |
| Characteristic of | Evaluation | S | A | B | A |
| protection film | | | | | |

TABLE 2

| | | | Example 5 | Example 6 | Example 7 | Example 8 |
|---|---|---|---|---|---|---|
| Mixing ratio | Resin (A) (% by mass) | | 70 | 60 | 70 | 80 |
| | Resin (B) | (% by mass) | 30 | 40 | 30 | 20 |
| | | Resin (B1) (% by mass) | 5 | 35 | 25 | 15 |
| | | Resin (B2) (% by mass) | 25 | 5 | 5 | 5 |

| Heat | D/H (° C./mW) | 144 | 36 | 97 | 14 |
|---|---|---|---|---|---|
| characteristic | Tmc (° C.) | 130 | 178 | 141 | 189 |
| | Number of melting peaks in | 1 | 2 | 1 | 1 |
| | raising temperature | | | | |
| Density (g/cm³) | | 1.3684 | 1.3576 | 1.3677 | 1.3768 |
| Formability | F100MD (MPa) | 5.6 | 7.2 | 5.4 | 9.4 |
| | F100TD (MPa) | 9.4 | 12.4 | 9.8 | 12.5 |
| | Evaluation 1/Evaluation 2 | S/A | A/B | S/A | A/A |
| Appearance | Evaluation | B | B | S | S |
| Characteristic | Evaluation | A | A | S | A |
| of protection | | | | | |
| film | | | | | |

TABLE 3

| | | | Example 9 | Example 10 | Example 11 |
|---|---|---|---|---|---|
| Mixing ratio | Resin (A) (% by mass) | | 75 | 75 | 50 |
| | Resin (B) | (% by mass) | 25 | 25 | 50 |
| | | Resin (B1) (% by mass) | 20 | 5 | 40 |
| | | Resin (B2) (% by mass) | 5 | 20 | 10 |

| Heat characteristic | D/H (° C./mW) | 7.6 | 131 | 58 |
|---|---|---|---|---|
| | Tmc (° C.) | 190 | 132 | 167 |
| | Number of melting peaks in | 1 | 1 | 2 |
| | raising temperature | | | |
| Density (g/cm³) | | 1.3704 | 1.3738 | 1.3482 |
| Formability | F100MD (MPa) | 9.8 | 8.4 | 6.9 |
| | F100TD (MPa) | 14.6 | 13.2 | 16.7 |
| | Evaluation 1/Evaluation 2 | A/A | A/A | A/B |
| Appearance | Evaluation | S | A | B |
| Characteristic of | Evaluation | B | A | B |
| protection film | | | | |

TABLE 4

| | | | Comparative | Comparative | Comparative | Comparative |
|---|---|---|---|---|---|---|
| | | | example 1 | example 2 | example 3 | example 4 |
| Mixing ratio | Resin (A) (% by mass) | | 80 | 30 | 90 | 60 |
| | Resin (B) | (% by mass) | 20 | 70 | 10 | 40 |
| | | Resin (B1) (% by mass) | 15 | 65 | 5 | 15 |
| | | Resin (B2) (% by mass) | 5 | 5 | 5 | 25 |

| Heat | D/H (° C./mW) | 2.8 | 2.1 | 1.9 | 152 |
|---|---|---|---|---|---|
| characteristic | Tmc (° C.) | 205 | 171 | 210 | 121 |
| | Number of melting peaks in | 1 | 2 | 1 | 1 |
| | raising temperature | | | | |
| Density (g/cm³) | | 1.3803 | 1.3265 | 1.3931 | 1.3582 |
| Formability | F100MD (MPa) | 24.8 | 8.2 | 22.9 | 5.9 |
| | F100TD (MPa) | 31.6 | 26.6 | 23.8 | 8.1 |
| | Evaluation 1/Evaluation 2 | C/B | C/C | C/S | S/S |
| Appearance | Evaluation | A | C | A | C |
| Characteristic | Evaluation | C | C | C | S |
| of protection | | | | | |
| film | | | | | |

TABLE 5

| | | | Comparative | Comparative | Comparative |
|---|---|---|---|---|---|
| | | | example 5 | example 6 | example 7 |
| Mixing ratio | Resin (A) (% by mass) | | 70 | 95 | 8 |
| | Resin (B) | (% by mass) | 30 | 5 | 92 |
| | | Resin (B1) (% by mass) | 30 | 1 | 92 |
| | | Resin (B2) (% by mass) | 0 | 4 | 0 |

| Heat characteristic | D/H (° C./mW) | 3.2 | 44 | — |
|---|---|---|---|---|
| | Tmc (° C.) | 184 | 149 | — |
| | Number of melting peaks in | 1 | 1 | — |
| | raising temperature | | | |
| Density (g/cm³) | | 1.3782 | 1.3924 | — |
| Formability | F100MD (MPa) | 12.4 | 42.3 | — |
| | F100TD (MPa) | 28.7 | 51.7 | — |
| | Evaluation 1/Evaluation 2 | C/C | C/B | — |
| Appearance | Evaluation | B | A | — |
| Characteristic of protection film | Evaluation | C | C | — |

Physical properties and evaluation result of film in each Examples and Comparative Examples are shown in Table 1 to Table 5. As shown in the Tables, our polyester films (Examples 1 to 11) are excellent in formability, appearance when a metal thin membrane is provided, and characteristics as a protection film, and can be suitably used as a film for metallic molded parts. On the other hand, films of Comparative Examples 1 to 7 had C evaluation on at least one of formability, appearance, and characteristic as a protection film, and were inferior.

### INDUSTRIAL APPLICABILITY

The polyester film for molded part has excellent processability, molded parts following a mold in thermoforming such as vacuum forming and pressure forming can be easily produced, further, by previously providing metal deposition before molding, it can be suitably used for parts of automobile parts and home appliances as molded parts having a plating-like appearance. Moreover, when it is used as a surface protection film in molding a formable decorative sheet, appearance of molded article can be maintained beautifully, thus it can be suitably used as a surface protection film of a formable decorative sheet.

1. A polyester film for molded parts comprising a film comprising a polyester resin composition mixed with a resin (A) of a polyethylene terephthalate and a resin (B) of a polyester selected from the group consisting of a polybutylene terephthalate resin and a polytrimethylene terephthalate resin where resin (A) is 10 to 90% by mass and resin (B) is 90 to 10% by mass based on the total of resin (A) and resin (B), wherein said resin (B) comprises a resin (B1) of a polybutylene terephthalate and a resin (B2) of a polytrimethylene terephthalate mixed such that resin (B1) is 10 to 90% by mass and resin (B2) is 90 to 10% by mass based on the total of resin (B1) and resin (B2), and
a ratio (D/H) of a half bandwidth D (° C.) of a recrystallization peak in falling temperature by differential scanning calorimeter (DSC) to the peak height H (mW) is 3 to 150° C./mW.

2. The polyester film of claim 1, wherein a recrystallization peak temperature (Tmc) in falling temperature by differential scanning calorimeter (DSC) is 140 to 205° C.

3. The polyester film of claim 1, which is a biaxially oriented film.

4. The polyester film of claim 1, wherein said polyester resin composition is mixed such that the resin (A) is 60 to 90% by mass and the resin (B) is 40 to 10% by mass based on the total of resin (A) and resin (B).

5. The polyester film of claim 1, wherein a melting peak in raising temperature by differential scanning calorimeter (DSC) is a single peak.

6. A film for metallic molded parts comprising: a metal compound deposited on at least one side of the biaxially oriented polyester film of claim 1.

7. The biaxially oriented polyester film of claim 1, which is laminated on a surface of a formable decorative sheet.

8. A formable laminate comprising the biaxially oriented polyester film of claim 1 laminated on a surface of a formable decorative sheet.

9. A method of forming a formable decorative sheet, comprising performing the formable laminate of claim 8, conducting trimming of the formable laminate, injecting a resin into the formable laminate, and peeling the biaxially oriented polyester film of claim 3.

10. A molded part obtained by peeling the biaxially oriented polyester film of claim 3 after molding the formable laminate of claim 8, wherein an absolute value of difference in surface gloss between the part and the formable decorative sheet before molding is less than 10.
